(19) United States
(12) Patent Application Publication
(10) Pub. No.: US 2006/0218079 A1
(43) Pub. Date: Sep. 28, 2006

(54) Web-based consumer loan database with automated controls for preventing predatory lending practices

(76) Inventors: Joel N. Goldblatt, Highland Park, IL (US); William T. Nadal, Novato, CA (US)

Correspondence Address: SANFORD J. PILTCH, ESQ., 1132 HAMILTON STREET, SUITE 201, ALLENTOWN, PA, 18101, US

(21) Appl. No.: 11/351,107

(22) Filed: Feb. 8, 2006

Related U.S. Application Data
(60) Provisional application No. 60/650,800, filed on Feb. 8, 2005.

(51) Int. Cl. G06Q 40/00

(52) U.S. Cl. 705/38

(57) ABSTRACT

A web based, interactive and collaborative software intelligence tool that tracks the patterns of behavior of mortgage originators, lenders, and others involved in the lending process and automatically identifies instances of non-compliance or potentially fraudulent activities or patterns of conduct that are deemed either deceptive to the borrower or anti-consumer by government agencies charged with oversight of the lending industry.

### BACKGROUND OF THE INVENTION

A software intelligence tool to track mortgage broker originators and lenders' behavior toward mortgage consumers to eliminate, or reduce predatory and fraudulent lending practices and reduce foreclosures resulting from such predatory lending practices in the form of a web-based interactive database will be utilized. The software tool will permit governmental regulators to generate comparative reports that will permit that regulator and other government agencies to review and discover patterns of conduct with regard to properties in designated geographic areas of municipalities or larger governmental entities by identifying mortgage loan originators, loan types, neighborhoods, zip code groupings, and other participants in the lending process such as real estate appraisers and title companies.

Various governmental authorities have the obligation of overseeing loan transactions to determine whether these transactions meet the minimum legal requirements, i.e., appropriately qualifying borrowers, so that the transactions can be made. Usually the oversight occurs long after the loan transaction is consummated, and usually at the time of a default or foreclosure action taken against the property that secures the loan. Determining that predatory or fraudulent transactions occurred months or years before surfacing does not serve to protect the community of borrowers and could be considered an abdication of the governmental oversight obligation to appropriately protect the borrowing consumer from such illegal practices.

The present invention will allow governmental regulators real-time oversight of loan transactions as each is progressing through the qualifying stages requiring entry of information about the property and the consumer borrower(s) by loan originators or lenders, credit counseling agencies, and title companies as each transaction moves from application through closing. The present invention enables data entry to a common database by each of the entities involved in the transaction, automatic oversight concerning qualification and the need for credit counseling, and the approval of the loan transaction prior to enabling a certificate necessary to record the new mortgage document and deed to the property.

### SUMMARY OF THE INVENTION

A web based, interactive and collaborative software intelligence tool that tracks the patterns of behavior of mortgage originators, lenders, and others involved in the lending process and automatically identifies instances of non-compliance or potentially fraudulent activities or patterns of conduct that are deemed either deceptive or anti-consumer by government agencies charged with oversight of the lending industry. To further assist with the reduction, and ultimately the elimination of predatory lending, the software provides an intelligence capability to identify high cost loans; risk factors that tend to be associated with loans that go into default, patterns of activity by those involved in the process or as evidenced by actions involving a property or neighborhood and alerts to regulators in threshold; and statistical measurements and rules.

The software tool enables web-based data entry from Lenders/Originators, Credit Counseling agencies, and Title Companies, and will have the ability to provide links to a number of financial and credit bureau gateways to provide accurate, real time information for the purpose of identifying unscrupulous behavior from lenders, and identifying high-risk borrowers. The database will also provide comparative internal measurements based upon transactions actually occurring in the market place and have the ability to compare a particular transaction to other transactions in a designated neighborhood, zip code or region.

The software will provide regulators with compliance tools and the ability to measure behavior and determine where foreclosures increase as a corollary to such behavior. The regulators will be able to identify patterns of such activity, whether the same parties are participating in a given pattern of conduct, where these activities are taking place and who is being harmed by such activities, as well as who might be benefiting from them.

The software system will offer an interface with credit counselors to review a particular loan transaction with a borrower who is referred to credit counseling and will offer the credit counselor the ability to take the borrower through the loan being quoted to assist the borrower's understanding of the overall financial transaction.

The software will afford users a flexible web-based, interactive and collaborative intelligence tool for detecting whether a loan applicant requires credit counseling by alerting the borrower(s), loan originators and title company to a requirement for the applicant(s) to attend a credit counseling session. This can be accomplished via e-mail to the data entry entity and will require notification to the borrower(s) that credit counseling is required before the loan process can continue. Whether the loan applicant is required to attend, has completed credit counseling is determined automatically by the present invention in accordance with established guidelines adopted by the governmental agency responsible for overseeing these types of transactions. All such transactions by data entry and notification are accomplished through a user intuitive interface over a secure communications pathway.

The present invention also allows the loan originator to amend the original loan transaction information prior to closing. When such changes occur, the software will track the number of changes or amendments made and analyze such changes to determine whether they remain within the guidelines. If the changes trigger a requirement for credit counseling, the software will call for an appropriate notice to be provided to the borrower(s) by e-mail or otherwise, along with a list of approved credit counseling agencies, and the process will be held in abeyance until the credit counseling takes place.

The present invention permits a representative of the governmental agency to access and track a loan transaction, and any amendments, to determine compliance with regulatory rules. The software has the capacity to automatically notify regulators of compliance requirements, i.e., notice due dates, and will also provide for monitoring licensee performance. If the software system notes that the original or amended loan application indicates predatory lending or a negative economic benefit to the borrower(s), e-mail communications can be generated to notify the regulator of a need to conduct an audit of the transaction and the licensee entity.

To further assist with the reduction or elimination of predatory lending, the software system provides an intelligence capability through customized reports that can help identify high cost loans, risk factors that tend to be associated with loans that go into default, patterns of activity by those entities involved in the lending process involving targeted properties or neighborhoods, etc., and statistical measurements and regulations that all can trigger alerts to regulators based on preset thresholds. In addition, the software system helps measure certain patterns of behavior and collates locations and times when foreclosures increase as a corollary of such patterns of behavior. Regulators will then be able to identify the patterns of behavior, the entities responsible for such behavior, where such actions are taking place, and identify who is being harmed and who is benefiting from such activities. Overall performance reports are also capable of being generated for supervision and efficiency of the program. Finally, the software system will assure that all participating entities, i.e., loan originators, credit counselors, title companies, and closing agents, comply with all regulatory restrictions built into the software concerning the particular agency utilizing the invention.

Other objects will appear hereinafter.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a flow diagram of the user interface for the loan originator.

FIG. 2 is a flow diagram of the user interface for the credit counselor.

FIG. 3 is a flow diagram of the user interface for the loan originator for amendments to the original loan terms.

FIG. 4 is a flow diagram of the user interface for the closing agent or title company.

FIG. 5 is a flow diagram of the user interface for the regulator or regulating entity.

FIG. 6 is a flow diagram of the user interface for the administrator in the regulating entity.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

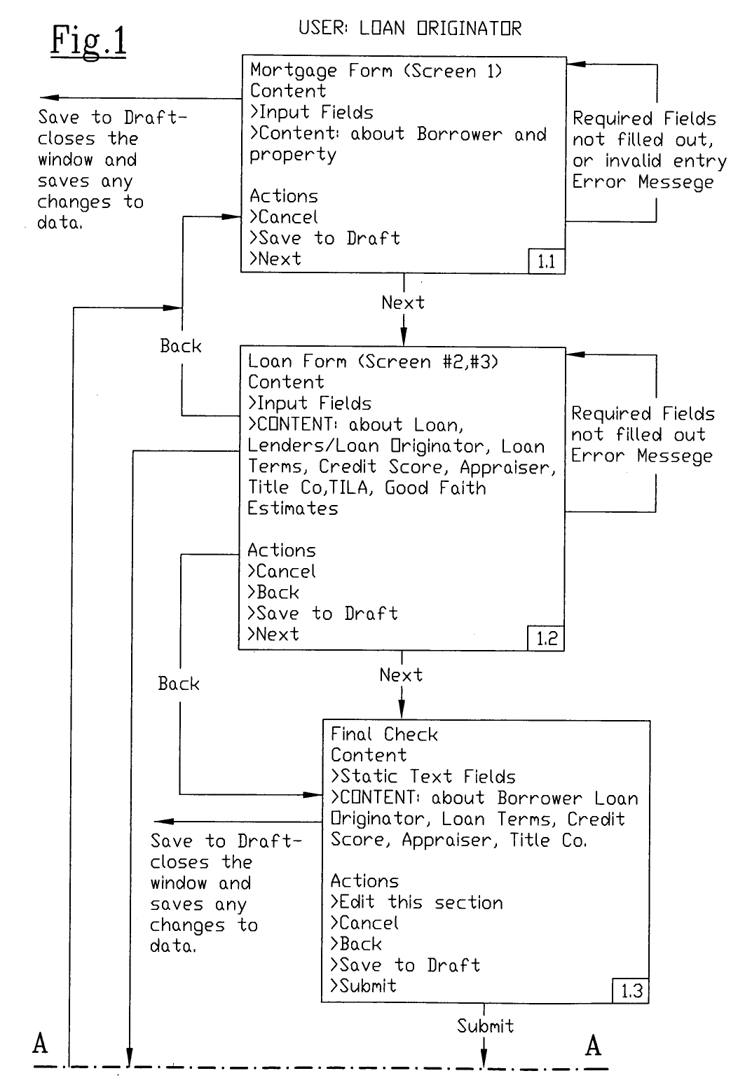

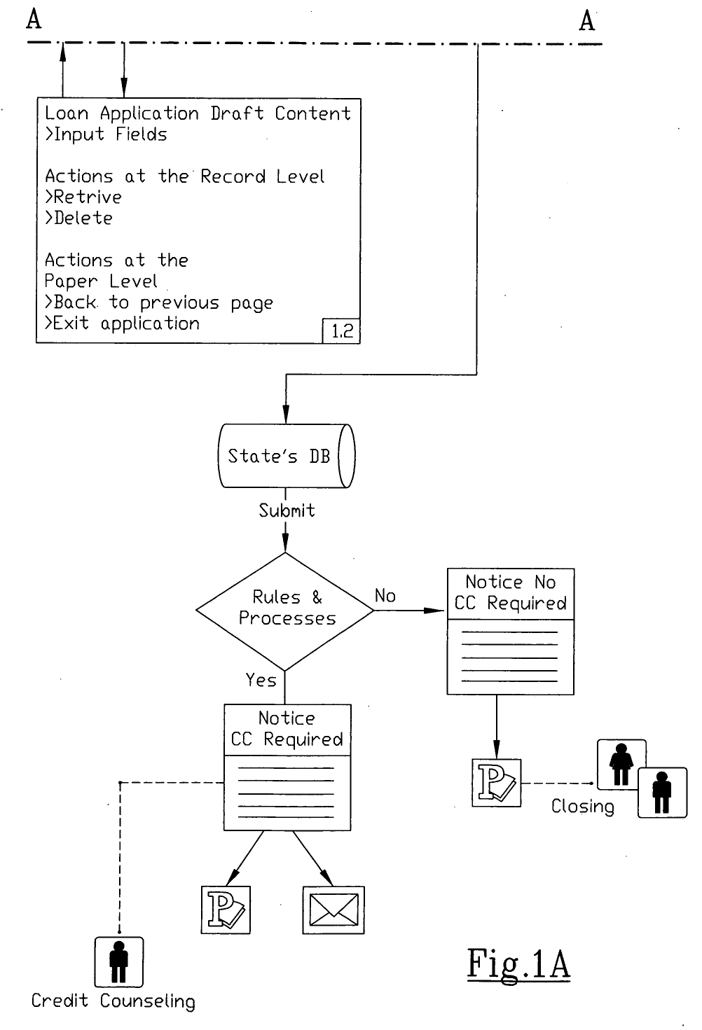

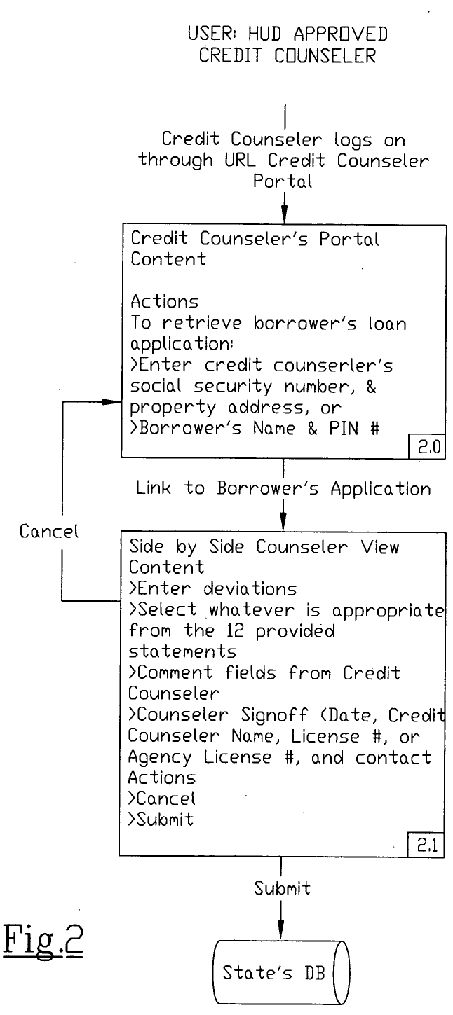

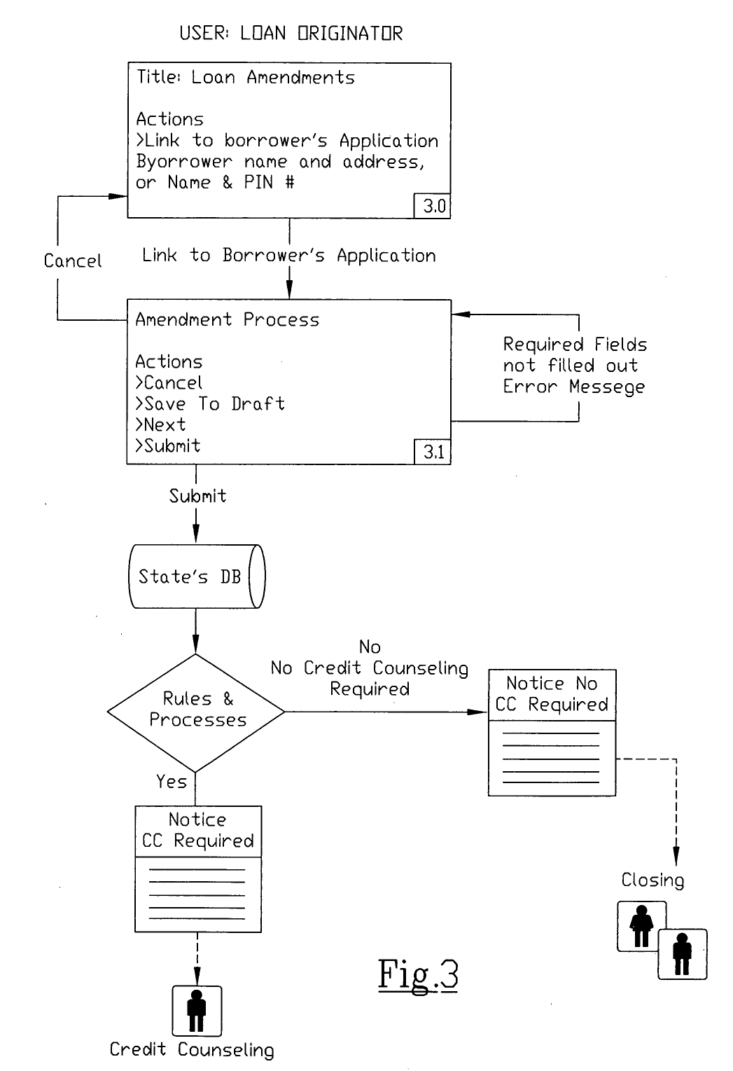

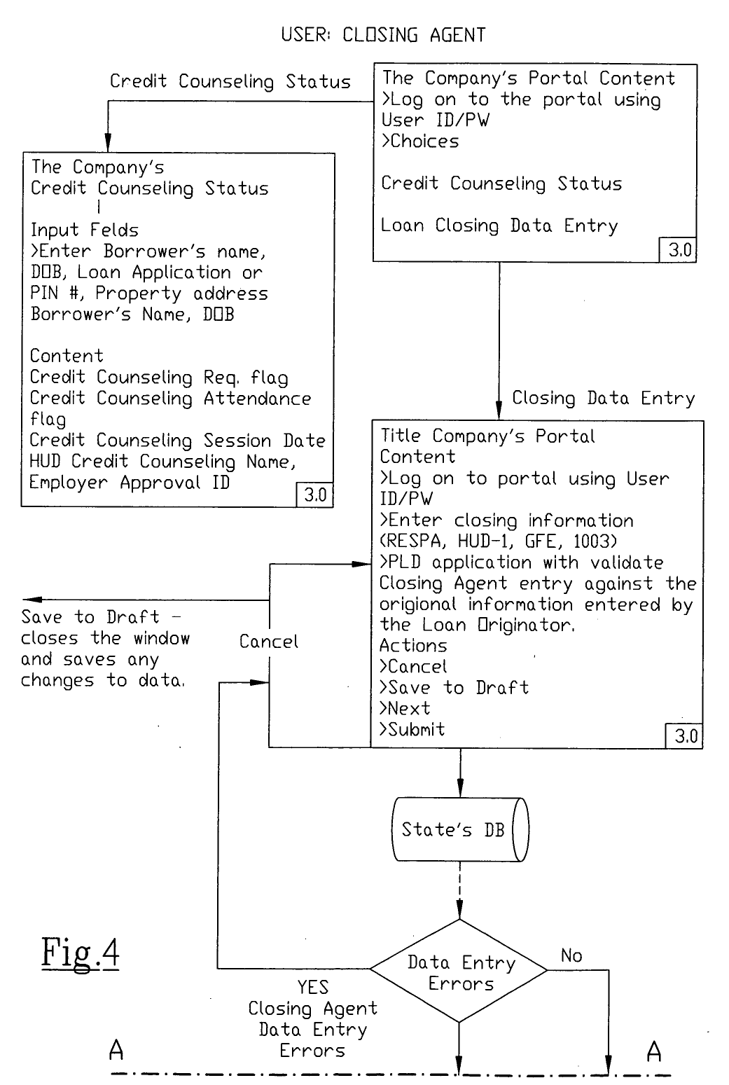

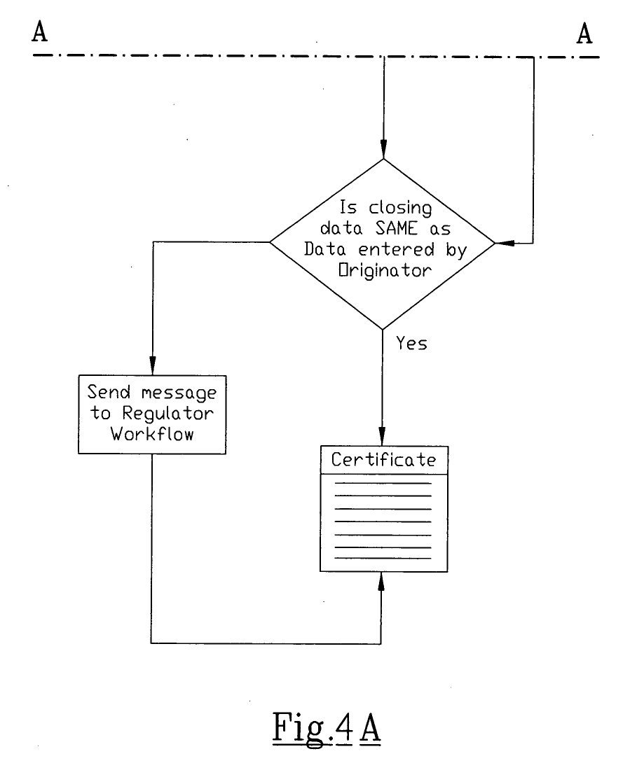

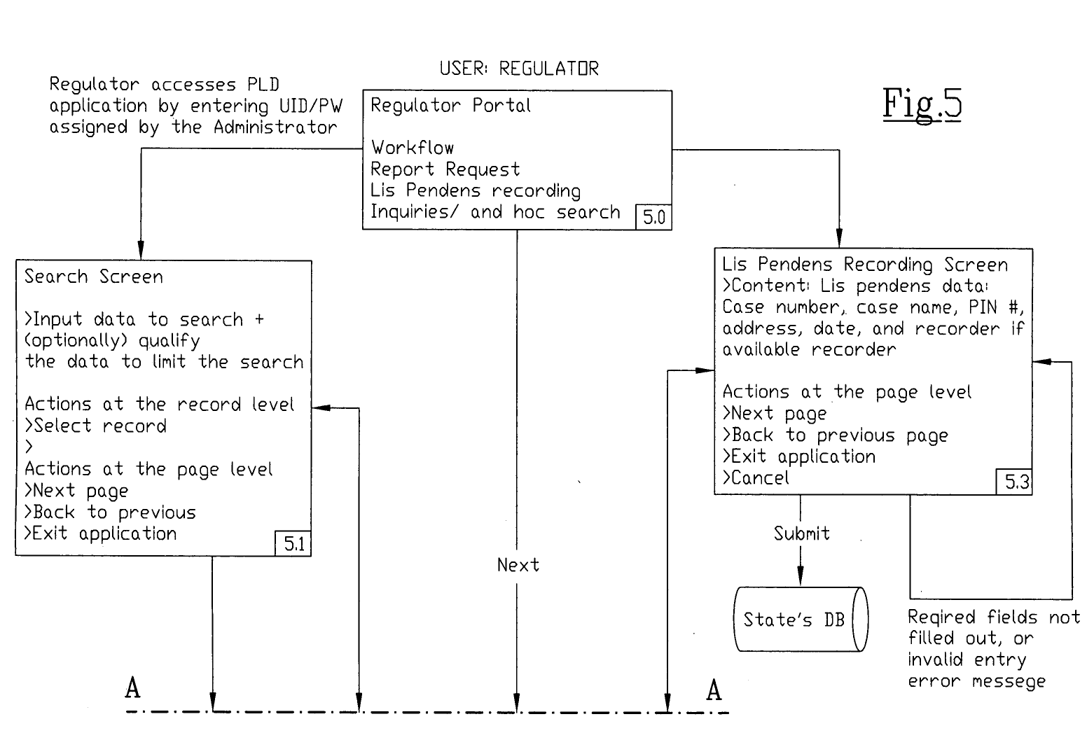

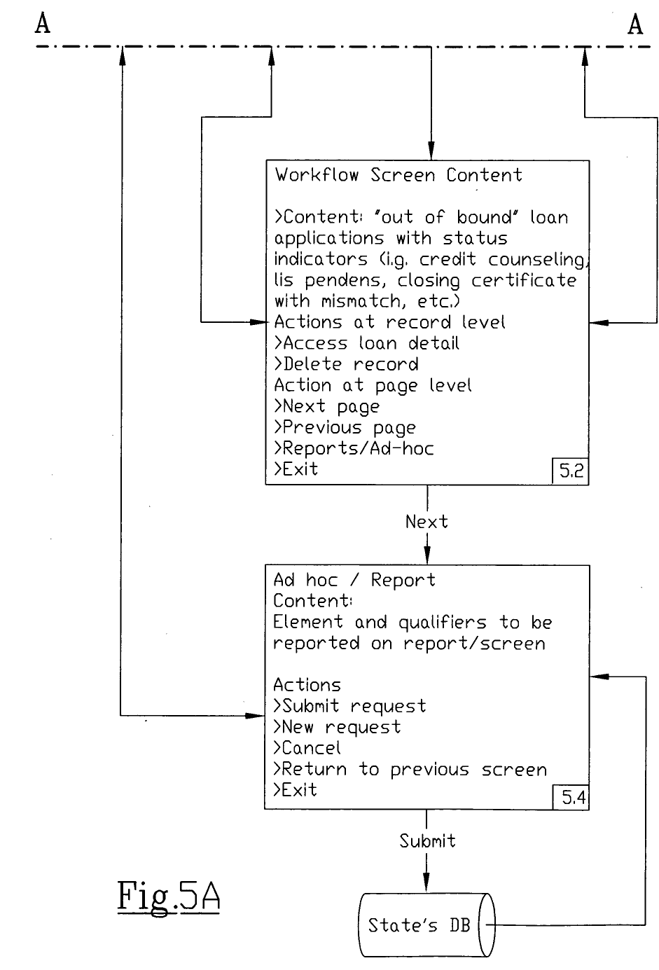

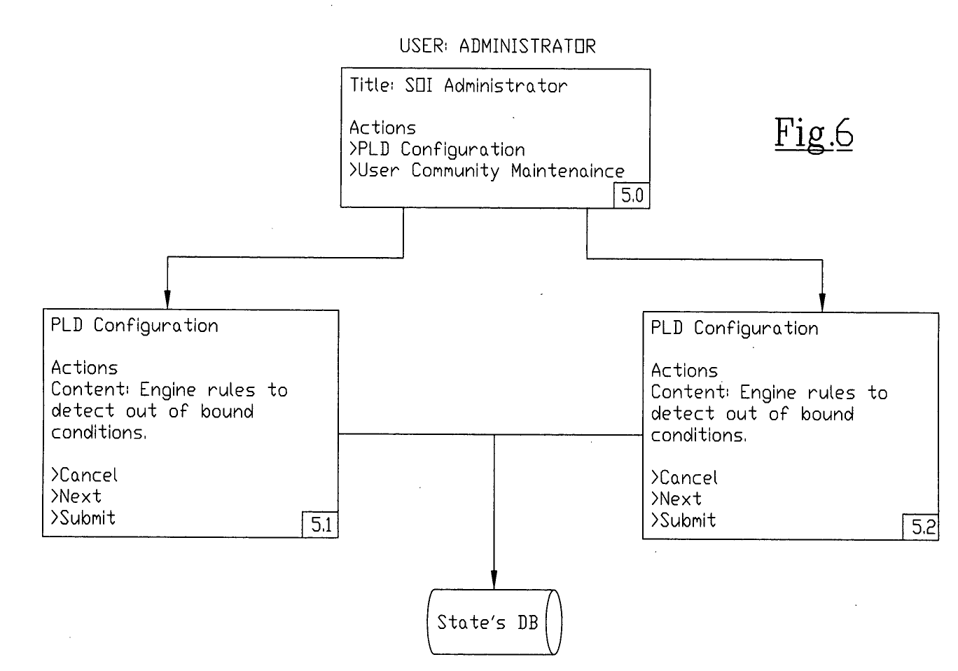

Reference may be had to the various drawing figures, i.e., FIGS. 1-6, in following the description of the software system and database of the present invention as presented below.

The present invention creates a method and automated process or system that will utilize a copyright protected database to combat predatory lending practices by unscrupulous third-party mortgage loan originators. The database will be utilized by various governmental regulatory agencies charged with oversight of certain loan transactions. The database requires the input by the loan originator, through a web based platform that calls for factual data concerning the loan terms being sought, the loan terms being procured, the borrower(s) personal and financial condition, and the service providers to the borrower(s) who are involved in the residential first or second mortgage loan, or home equity loan transaction. The database will also permit amendments to be made by the loan originator prior to closing.

The software system and database will alert borrowers, loan originators and title companies (if known during the loan application entry) of an applicant that are determined to require credit counseling based upon governmental regulations. The software will automatically contact participating loan originators via e-mail or via telephone messaging of the determined requirement for an applicant to attend credit counseling. This will trigger the loan originator to send a notice to the borrower(s) that credit counseling is required and also provide a list of approved credit counseling agencies. All of these actions are accomplished through a user intuitive interface over a secure communications pathway.

The database will also permit, through web-based access, HUD approved credit counselors to review the borrower and proposed loan information with the borrower(s) referred for credit counseling. The credit counselor will have access to the database to enter the assessment based upon the interview with the borrower(s) and the date that such interview took place. In addition, the credit counselor will be required to enter any inconsistencies between the information entered by the loan originator and the results of the interview with the borrower(s) as conducted through prompts and checklists to the credit counselor to lead the counselor through the interview of the borrower(s). Any difference in the information provided by the borrower(s) between that entered by the loan originator and that entered by the credit counselor will enable the software system to measure the performance of the loan originator and to ensure that a fair credit counseling assessment is entered into the database within the time permitted for doing so.

The database also provides web-based access to title insurance companies who will enter data regarding the loan(s) to complete RESPA HUD 1 Settlement statement data, Truth in Lending Good Faith Estimates, Regulation Z notices, and any other local Forms that are required to be entered into the database. The database will compare the information entered by the title company to that entered by the loan originator and, if discrepancies are detected, an automated notice will result to advise the title company to verify its information. If the title company entries are accurate in view of the loan actually executed by the borrower(s) the system will create a certificate of completion to be printed once all data from the originator and the title company (and if one was involved the Credit Counselor) has been entered into the database, but retain the list of any discrepancies for later review and audit by the regulating agency. The system will then allow the closing (completion and disbursement) by the title company and the printing of a Closing Certificate that will note any discrepancies that exist between the entries of the loan originator and the title company, and may be recorded with the mortgage.

The software system and database can be accessed through any currently known communications pathway, e.g., broadband, dial-up or virtual private network computer connection. Each segment of the software system and database has a unique portal for access depending upon the type of entity using the system.

The following is a description of the fields of data to be collected and stored by the database segregated by entity type and portal nomenclature. The pages that follow set forth a flow of the methodology and users of the software system and database, as well as describe input screens that evidence the look of the web-based interfaces between the originator and the regulator's web site, the credit counselor and the regulator's web site, and the title company and the regulator's web site.

Loan Originator Portal and Interface

The Loan Originator Portal will include the data entry necessary to complete the RESPA HUD 1 Settlement Sheet, residential loan application forms, Good Faith Estimates of closing costs, Regulation Z and TILA disclosures. This information is required to make the determination if the borrower(s) is/are required to participate in credit counseling, either due to a detected predatory lending action or because the borrower(s) cannot meet the new financial obligation based on a debt to income ratio. Further, the requirement to enter the borrowers' information as part of an application stored in the database will ensure the entry of the information within the permitted time frame pursuant to any statute or regulation.

The information to be collected includes, but is not limited to the following:
1. name and address of the borrow(s)
2. Social Security number of borrower(s)
3. photographic identification of borrower(s), e.g., drivers license,
4. identifier or PIN for property,
5. description of property to be used as collateral describing its type, e.g., single family residence, duplex., multi-unit, commercial, industrial, etc.,
6. loan amount requested and whether for personal or business use,
7. address of property to be used as collateral,
8. current title holder,
9. borrower's income range set forth on the application and place of employment, title or position, and whether an ownership interest in employer exists;
10. credit score of the borrower(s) at time of application,
11. name, address and contact information including telephone numbers and e-mail addresses for all mortgage brokers and their license numbers,
12. name, address and contact information including telephone numbers and e-mail addresses for all loan originators and their license numbers,
13. name, address and contact information including telephone numbers and e-mail addresses for all title companies,
14. name, address and contact information including telephone numbers and e-mail addresses for all surveyors and their license #,
15. name, address and contact information including telephone numbers and e-mail addresses for all appraisers,
16. name, address and contact information including telephone numbers and e-mail addresses for all real estate brokers,
17. name, address and contact information including telephone numbers and e-mail addresses for all real estate sales persons,
   While the names and license numbers of the loan originator and the lending entity he works for are required to be entered, the license numbers for the appraiser, the realtor, and the title company can be optional according to local statute and/or regulation.

The information that is required to be included for each loan application, as set forth above, also includes any Promissory Note and Mortgage terms such as the following:
1. points as both a percentage and actual dollar amount;
2. yield spread premium earned by originator on each loan,
3. interest rate and type of note, e.g., adjustable or fixed rate,
4. prepayment limitations or restrictions, if any,
5. total amount of loan and whether negative amortization is possible during the loan term,
6. statement of monthly payment indicating both principal and interest amounts, the amortization period and whether the loan is subject to a balloon payment,
7. whether the loan is for the purchase of a new property or the refinance of a property already owned by the borrower(s),
8. if a refinance, the amount of the earlier loan,
9. the current balance of indebtedness to be paid off (both secured and unsecured) with each indebtedness detailed and then totaled,
10. the identity of the surveyor, appraiser and realtor, if known,
11. the application must state if a first or second mortgage, or both;
12. if two or more loans are contemplated all loans terms must be registered and the 2^{nd} loan needs to refer to the file number of the first as applied for and so forth;
13. estimated closing costs shown on truth in lending form must be reported in itemized fashion,
14. all fees of originator both paid before, at and outside of closing, not set forth above,
15. annual real estate tax for the property and, if a condominium or shared property, the monthly assessment and any special assessment, if known,
16. any escrow terms, e.g., taxes, etc.,
17. whether credit life insurance is to be sold with the loan, and the amount,
18. the purpose for the loan, e.g., new acquisition, refinance for better rate, debt consolidation; home improvement, business,
19. whether there is a housing court case pending with the case no., if loan is for required repairs,
20. the notices provided in accordance with Good Faith Estimate of Closing Costs, given or not, and date,
21. Truth in Lending Escrow Disclosure, given or not, and date,
22. whether this is a “no document” program,
23. whether YSP is disclosed to borrower and date and form of disclosure (oral, written or electronic),
24. if a document program, has originator received a copy of tax returns,
25. name of person or company who prepared the tax returns for applicant,
26. income of applicant in ranges,
27. applicant's credit score(s),
28. cost of credit report and application fee to originator and whether application fee is to be paid at application or closing,
29. information about the originator and how they obtained applicant, e.g., direct mail, cold call referral, door to door, repeat customer, other,
30. file number as assigned by system
   Following the entry of all of the required data and information in the appropriate fields, the Loan Originator Portal must also be able to accommodate a printing function. The ability to print and/or reprint any required Notices, particularly whether an applicant is required to seek credit counseling, is a necessary function. The Portal must also facilitate contact with the borrower(s) and other participants in the program. These include the title company (if known at the time of taking the original application) the loan originator. Contact can be initiated via e-mail, telephone messaging, or regular mail, as required by statute or regulation.
   Loan Originator Amendment Interface

The above fields will be required to be displayed with boxes underneath for amendment purposes so that any item of information to be changed prior to closing can be identified. In each instance the reason for the change must be noted in accordance with the following instruction—Check all those that apply:
Different program ______; better rate ______; switch from fixed to adjustable ______; borrower's credit score worsened ______; different program required ______; first lender rejected ______; with date of letter or rejection ______; borrower did not qualify ______; with brief reason or description (income too low, debts too high, not enough money down, credit rating score, etc.
   There should also be a fill-in text box for the name of any credit counselor recommended by loan originator. In this manner, the software system and database provide a mechanism to both track changes and allow the changes to be made and viewed in connection with an open loan application and/or loan. The software will monitor whether any change will trigger a requirement for credit counseling by determining whether the amended terms fall “out-of-bounds” for the accepted credit counseling conditions. If this occurs, the software system will mandate credit counseling whether or not the borrower(s) previously were required to attend a credit counseling session. A Notice to attend credit counseling is generated and printed and the software system automatically re-contacts the persons involved as described above. If any amendment does not materially change the risk associated with the loan and a previously mandated credit counseling session, the subsequent credit counseling session may be limited to a discussion of the changes made to the loan terms, associated risk, etc. that are different from the prior credit counseling session.
   Credit Counselor Portal and Interface

The Credit Counselor will act to verify the entered data and information in each field with a corresponding field beneath to record changes. The fields set forth below will be recalled automatically from the database as filled out and submitted by the loan originator. These original fields will be static and the credit counselor will be able to submit his or her information as gathered directly from the applicant in the corresponding field text boxes. The software system will provide the credit counselor with all of the information entered into the database by the loan originator as obtained from the applicant. The data will be displayed in such a manner SO as to enable the credit counselor to verify the information with the applicant and to enter any changes in the corresponding text box fields appropriately positioned below or to one side of the originally entered information. The software system will enable the credit counselor to provide an overall assessment based upon data and information obtained from the applicant as required by statute or regulation. In addition, the software will track the individual credit counselor identification number to ensure that any issues regarding the counseling arise, the system can direct the inquirer to the credit counselor that provided the particular counseling.

The credit counseling required the counselor to re-interview the applicant and to obtain the response to the same questions asked by the loan originator. These seventeen (17) items of information are set forth above and include, without limitation, the personal information of the applicant/borrower, identifying indicia for and owner of the property, amount requested for the loan, credit score for all borrowers, and identifying indicia for mortgage brokers, loan originators, title companies, surveyors, and appraisers. The credit counselor need not, in all cases, verify the identifying indicia for real estate brokers and real estate sale persons. However, the names and license numbers of the originator and the company he works for are required to be verified, but the license number for the appraiser, title company and the realtor need not, in all cases be required to be verified.

For each loan application for which credit counseling is required, the counselor is mandated to review with the applicant(s) all of the thirty (30) items as set forth the above concerning the Promissory Note and Mortgage terms. In addition, the credit counselor will note the following and enter the response(s) received from the applicant(s) accordingly:

Where applicant was given notices did they understand them:
Yes ______ No ______ Understanding Marginal ______

Does the applicant speak English? Yes ______ No ______

Does the applicant have any physical disabilities?
Hearing ______ Vision ______ Mental ______ Physical Impairment ______

Race of applicant:
Caucasian ______ African American ______ Hispanic ______ Asian ______ American Indian ______ Other ______

Is applicant a U.S. Citizen? Yes ______ No ______

A text box should be provided for the counselor's brief comments or any problems noted, including any recommendations regarding the applicant(s) or the loan process. The credit counselor must then give an assessment of the loan as follows:

Loan should not be approved indicia of fraud ______

Loan should be approved, no material problems noted ______

Borrower cannot afford loan ______

Borrower's ability to afford loan is suspect ______

Borrower does not understand transaction ______

Borrower does not understand costs ______

In addition, the credit counselor will be required to indicate whether the applicant(s) discussed their economic position with the counselor and received the recommendations of the counselor in accordance with the following example.

Borrower had their monthly income and expenses reviewed and disclosed to them ______ Do not proceed with loan, cannot afford ______ Discrepancies noted between applicant's verbal understanding and originator's completed form ______ Borrower precipitously close to not being able to afford the loan ______ the true cost of debt consolidation and the need for discipline in running up more credit card debt discussed ______.
   Title Company or Closing Agent Portal and Interface

At the time that a closing on the loan between the borrower(s) and the lending institution occurs, a title company or closing agent will be able to gain access to the application and loan document data entered in the database and view the completed information. The representative of the title company or the closing agent will then be able to compare the data and information on hand with the data and information previously entered in the database. This will include the RESPA HUD 1 Settlement Sheet, Regulation Z and TILA Good Faith Estimate information, and local regulatory documents. The closing agent, upon entering the data and information on hand, will be able to review, compare and verify the data and information as originally entered and/or amended by the loan originator. The data and information entered by the closing agent against the original or amended data and information will automatically be compared to the existing data and information in the database to determine if there are any discrepancies. If discrepancies are detected the closing agent will be prompted to verify the title company entries. The closing agent will be required to complete the following list of data and information. A number of preselected fields or text boxes indicated by a “!” will automatically appear and populate the screen for the title company or closing agent input. In the listing below the indication of the “!” requires the title company or closing agent to input comparative data and the indication [ONLY] means the title company will not be able to review the original response of the borrower(s) as originally entered and or amended by the loan originator and the title company must resubmit the responses given it by the borrower(s) for the software system to automatically compare. The list of information and the requirement to input new or confirming information appears below.
1. ! name and address of the borrow(s)
2. ONLY Social Security number of borrower(s)
3. ONLY photographic identification of borrower(s), e.g., drivers license,
4. ! identifier or PIN for property,
5. ! description of property to be used as collateral describing its type, e.g., single family residence, duplex., multi-unit, commercial, industrial, etc.,
6. ! loan amount requested and whether for personal or business use,
7. ! address of property to be used as collateral,
8. ! current title holder,
9. NOT DISPLAYED
10. NOT DISPLAYED
11. ! name, address and contact information including telephone numbers and e-mail addresses for all mortgage brokers and their license numbers,
12. ! name, address and contact information including telephone numbers and e-mail addresses for all loan originators and their license numbers,
13. ONLY name, address and contact information including telephone numbers and e-mail addresses for all title companies,
14. ! name, address and contact information including telephone numbers and e-mail addresses for all surveyors and their license #,
15. ! name, address and contact information including telephone numbers and e-mail addresses for all appraisers,
16. ! name, address and contact information including telephone numbers and e-mail addresses for all real estate brokers,
17. ! name, address and contact information including telephone numbers and e-mail addresses for all real estate sales persons,
   The re-entering and comparison checking of the name and address, contact information and license numbers for the surveyor, the appraiser, and the realtor(s) can be optional according to local statute and/or regulation.

The information that is required to be checked and compared by the closing agent for each loan application, as set forth above, also includes any Promissory Note and Mortgage terms such as the following:
1. ONLY points as both a percentage and actual dollar amount;
2. ONLY yield spread premium earned by originator on each loan,
3. ONLY interest rate and type of note, e.g., adjustable or fixed rate,
4. ONLY prepayment limitations or restrictions, if any,
5. ONLY total amount of loan and whether negative amortization is possible during the loan term,
6. ONLY statement of monthly payment indicating both principal and interest amounts, the amortization period and whether the loan is subject to a balloon payment,
7. ONLY whether the loan is for the purchase of a new property or the refinance of a property already owned by the borrower(s),
8. ONLY if a refinance, the amount of the earlier loan,
9. ONLY the current balance of indebtedness to be paid off (both secured and unsecured) with each indebtedness detailed and then totaled,
10. ! the identity of the surveyor, appraiser and realtor, if known,
11. ONLY the application must state if a first or second mortgage, or both;
12. ONLY if two or more loans are contemplated all loans terms must be registered and the 2^{nd} loan needs to refer to the file number of the first as applied for and so forth;
13. ! estimated closing costs shown on truth in lending form must be reported in itemized fashion,
14. ONLY all fees of originator both paid before, at and outside of closing, not set forth above,
15. ONLY annual real estate tax for the property and, if a condominium or shared property, the monthly assessment and any special assessment, if known,
16. ONLY any escrow items and terms, e.g., taxes, etc.,
17. ONLY whether credit life insurance is to be sold with the loan, and the amount, and whether any credit life insurance is being purchased
18. NOT DISPLAYED
19. whether there is a housing court case pending with the case no., if loan is for required repairs,
20. ONLY the notices provided in accordance with Good Faith Estimate of Closing Costs, given or not, and date,
21. ONLY Truth in Lending Escrow Disclosure, given or not, and date,
22. NOT DISPLAYED
23. NOT DISPLAYED
24. NOT DISPLAYED
25. NOT DISPLAYED
26. NOT DISPLAYED
27. NOT DISPLAYED
28. ONLY cost of credit report and application fee to originator and whether application fee is to be paid at application or closing,
29. NOT DISPLAYED
30. ! file number as assigned by system
31. ONLY the notices provided in accordance with Good Faith
32. ONLY Truth and Lending Escrow Disclosure
33. ONLY transferring of Servicing and Escrows, as well as right of rescission for refinances, must have input text boxes providing transferee servicing and escrow agent(s)
34. ONLY Notice of transfer of servicing and escrow agent(s) to be certified as given or not given to borrower(s), with the date of such Notice
35. ONLY existence of a lender call provision in the loan, e.g., balloon payment, number of years or on demand
36. ONLY title company required to list name borrower and seller if an acquisition
37. ! whether appraiser examined interior/exterior—OPTIONAL
38. ! cost of appraisal, if on RESPA form
39. ! names and addresses of attorneys, if any
   Following the entry of all of the required data and information into the database over the secure communications pathway, the software system will automatically compare the entered information and determine if there are any discrepancies. If discrepancies are noted the closing agent will be prompted to verify the entered information and, once verified by the closing agent as correct, the software system will generate a Closing Certificate even though there may still exist a mismatch with the data entered by the loan originator. Any remaining discrepancies will be noted and printed on the Closing Certificate so that performance measurements may be made and stored in the system. The regulating agency will be notified via e-mail of the loan file with the noted discrepancies so that an audit can be performed.
   The Regulator Portal and Interface

This interface permits the regulator to track data in the system in a number of comparative ways and may be considered to be similar to a system administrator in the capability to review, in the audit function, each of the screen displays of the various data input entities as of the date that such data was entered into the database. Thus, the regulator will be enabled to search the database by loan file number, or by the names of the loan originator, credit counselor or closing agent (title company) in order to perform the oversight audit checking to accomplish the review of the information entered in the database.

In order to search and review or audit transactions stored in the database the regulator must be able to pull up each screen and display the data inputs at the level of the loan originator, the credit counselor, the title company and any amendments to the data inputs and the dates of those amendments. The regulator will be able to pull up a comparison table of the text fields for each entry item compared with same data in the text fields entered by others. In this manner an audit of a single transaction can be accomplished.

The regulator will also be able to sift through the database information by searching on each licensed participant in a number of transactions and then see everything that such a person/company has been involved with over a predefined period of time set by the regulator. A search can also be accomplished utilizing municipal boundaries or by zip code, by property location or address, by loan parameters, or by other defined text fields such as percentage of closing costs to net proceeds received by the borrower, and the like, where other participants were involved. The various participants would include the loan originator, mortgage broker, lender, title company, appraiser, realtor, credit counselor, and attorney. This type of search would develop a number of transactions, for example, 10 transactions in one zip code in one year, and retrieve the dates of the transactions, the loan file numbers, the prepaid interest points, the yield spread premium (“YSP”) charged, the PINs and loan amounts and develop a printable report for review and audit tracking.

Another search can be accomplished utilizing the percent and number of loans written by a lender, loan originator, or mortgage broker in a selected zip code. For each lender, loan originator, or mortgage broker a search can be done to identify the third-party providers used by each type of entity whether as a percentage of all loans underwritten, or within a zip code, or within a period of time. The database will permit adding to such searches the number of loans within a given rate range, or above a stated rate, or within a zip code, or with certain participants included and others excluded in a Boolean style expression. A comparison by lender, mortgage broker or loan originator of rates quoted or closed in a given neighborhood and those in other zip codes to determine redlining can also be accomplished. The regulator will also have the capability to search borrower salary ranges and compare to rates quoted and closed for all members of such class, or by zip code of such class.

The database will be able to track all applications and all loans actually issued and categorize these completed or partially completed transactions in different categories, for example, those transactions with prepaid interest points, those without prepaid interest points, those with more than 1 prepaid interest point, those with prepayment penalties, those transactions that are adjustable rate mortgages (“ARMs”), those that are fixed rate, those that called for 2 loans, a 1^{st} and a 2^{nd} mortgage loan. It will be possible to note what percentages of the loans reflect the involvement of a particular company or originator, or other licensee.

The database will have text fields to enter additional information about delinquencies of loans placed by a loan originator, lender or mortgage broker as reflected from lis pendens notices forwarded back from the Recorder of Deeds office to the regulator, or regulatory agency, that can be added to the database by either the regulator or Recorder. The database will be able to tabulate and sort all loan files within a selected time period, or in a zip code, or in a range of income for the borrower or applicant, and determine whether a first or second mortgage was secured and identify whether a certain loan originator, or a number of originators, lenders or brokers participated in the sorted transactions. The database can also be accessible for searching individual properties by PINs reflecting all loan activity for a selected property. The database will be able to track any differences between loan applications and actual loans that have been closed and print reports for regulatory audits, as necessary.

The database will be enabled to search for those lenders or loan originators who have certain features, such as credit life or prepayment penalties or points in excess of a given level, and then return to the regulator the information pertaining to loan file number, PIN, zip code address and date. The database will contain the names, addresses, contact information and license numbers of all licensees, and in the case of mortgage brokers, all loan originators working for, or affiliated with them. For all mortgage brokers and loan originators, the database will additionally store their respective home addresses and social security numbers along with dates of birth to accurately identify the individual(s). Also required are the names, addresses and social security numbers and residential addresses of all officers and directors and shareholders or members of any corporation and/or limited liability company that is a registered licensee. For all such listed individuals, a brief description of their respective duties and involvement with the licensee will be required.

Financial information of mortgage brokers, i.e., capitalization or audited net-worth, will be permitted to be entered in the database for regulator review along with the fees assessed and paid for licensing, as well as penalties and dates and amounts of payments, and bonding information including the amount and surety name. Additional information about the licensee's last audit by the regulatory agency, the next scheduled audit and whether a notice of audit has recently been issued, the date thereof and whether the audit has been re-scheduled, conducted and any adverse results or whether licensee passed, will also be available to the regulator as part of the audit information. Licensees will be required to annually provide examples of the types of advertisement utilized (print, direct mail, web, e-mail, TV, cable) and the expense amounts for the various advertisements in the previous period. Results of each audit, numbers and dates of complaints, and the names and contact information of any who complained, and result of an investigation, if any, must also be retained in the database.

The regulator should be able to track a borrower and review the number of loans in a borrower's name with the loan file number, PINs, addresses, dates and loan amounts for each transaction, as well as the number of times the same Seller is detected. The software system will indicate the loan file numbers, PINs, zip codes and addresses involved and print a report, as requested by the regulator. The regulator will be able double-click on a loan file number to access the information for that loan and have the complete loan transaction information displayed for review.

The software system and database will also be able to determine all participating entities that are current with financials, license fees, audits and the like, along with the current status of license or application for a licensee's good standing, under investigation, suspended, denied, sanction pending, or recently assessed. The database is capable of tracking all individuals affiliated or associated with a participating entity who may have revoked, suspended or sanctioned licenses and be able to cross-reference to the transaction and/or event to determine any possible infractions of statutes or regulations, or detect any predatory practices by an individual or participating entity. All of the described search activities will include the capability of generating a stylized report compiled for storing in the database, and printing for immediate use by the regulator.

In summary, the regulator will have the capability in using the software system and database of navigating through detailed information pertaining to the borrower(s), the loan transaction, or any participating entity and/or individual to accomplish the searching activities described above. In addition, the regulator will have a workflow review of a preselected number of loan transactions that require audit tracking and review due to detected discrepancies in information entered at different times, lack of appropriate Notices given to borrowers, and the like. A regulator will be required to review a loan transaction and determine whether such transaction is acceptable according to statutory and regulatory guidelines before approving the transaction. When approved by a regulator, the loan transaction will be de-listed from the regulator's workflow screen, but retained intact in the database until a regulatory system administrator requests download and storage of the information and a purge of the transaction data from the database.

The regulator also has the capability of configuring the workflow portal to accomplish the searching activities, as well as reviewing the loan transactions that require regulatory review before final acceptance. The regulator is also capable of designing reports, through the software system interface, to meet statutory and regulatory guidelines for reporting information in performing audits of transactions covering a predetermined number of criteria to make reasoned determinations if predatory practices are occurring in certain areas. The regulator will also be able to administer user access fees for all participating entitites.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A method for detecting consumer fraud and predatory lending practices to be utilized by a regulatory entity comprising the steps of:
a. providing a secure repository of data records accessible by participating entities over a plurality of secure communications pathway;
b. collecting predetermined data and information about borrower/applicants and loan parameters from each participating entity in sequence including loan originators, credit counselors, title insurers and loan closing agents;
c. determining whether the data and information collected is within the scope of and meets federal or state statutory and regulatory guidelines, or other local laws, pertaining to the sale and acquisition of real property;
d. determining whether a borrower/applicant understands the terms and conditions associated with the loan and is capable of meeting the debt obligation;
e. determining whether the borrower/applicant requires credit counseling and providing notice to the borrower/applicant and referral to a credit counselor;
f. providing the regulatory entity with real-time loan application information pertaining to all loans originated by licensees including mortgage brokers, loan originators, or other lending institutions;
g. providing participating entities with real-time access to the secure repository of data records over secure communications pathways to act upon loan applications that require credit counseling to the borrower/applicant;
h. providing a certification at the closing stage of the loan that compliance with all statutory and regulatory guidelines have been met, all data and information required has been entered in the secure repository, and by which participating entity; and,
i. determining whether any of the participating entities does not meet the statutory or regulatory guidelines pertaining to the sale and acquisition of real property.

2. The method of claim 1, wherein the data collection step is further comprised of the additional steps of:
a. entering borrower/applicant personal identifying information, property information and loan information including fees and charges, yield spread premium to be earned by any loan origination participating entity, and all information required to be furnished to the borrower/applicant in accordance will all applicable laws for real estate transactions in the locality of the transaction;
b. enabling loan originators to amend loan and borrower/applicant data as loan terms change;
c. enabling the credit counselor to review borrower/applicant data and information already entered into the data repository and to provide an assessment of the ability of borrower/applicant to repay loan and terms and conditions of the loan;
d. enabling a title company or closing agent to enter closing costs and verify that closing loan terms and clauses are the same as previously agreed to and understood by the borrower/applicant; and,
e. enabling regulators/auditors the ability to review and retain the data and information collected for a loan transaction and contemporaneously monitor the loan processing and the involved participating entities.

3. The method of claim 1, wherein the detection of a participating entity failure to meet statutory or regulatory guidelines step is further comprised of the additional steps of:
a. defining rules to detect high cost home loans based on:
i. balloon payments;
ii. negative amortization and amortization terms;
iii. adjustable interest rate terms and adjustment dates;
iv. monthly principal and interest payments;
v. taxes and condominium or other assessments;
vi. escrow terms and amounts;
vii. excessive fees or assessment of fees when borrower/applicant has no tangible economic value from refinancing
viii. default rates of interest;
ix. pre-payment fees or payments;
x. advanced payments;
xi. modification of deferral fees;
xii. mandatory arbitration;
xiii. loan flipping that creates no net economic benefit to borrower/applicant;
xiv. interest rates exceeding predetermined limitation;
xv. unexplained sale of mortgage related products based on personal information of borrower/applicant;
b. detecting potential predatory practices by participating entities by reviewing loan transactions entered into the repository of data records based upon the geographic location of property, a selected time period, and borrower/applicant personal data and information.

4. The method of claim 1, wherein the detection of a participating entity failure to meet statutory or regulatory guidelines step in detecting fraudulent short-term loans is further comprised of the additional steps of:
a. defining rules to detect fraudulent short-term loans including, but not limited to, detecting loan interest rates that exceed the permitted range or ceiling;
b. defining rules to detect fraudulent or predatory conduct on the part of participating entities;
c. defining rules to alert regulators to participating entities acting with a pattern of conduct that is defined as predatory or fraudulent in a selected geographic locale;
d. detecting patterns of conduct that reflect predatory or fraudulent activities by a participating entity in a selected geographic locale;
e. detecting patterns of conduct that reflect predatory or fraudulent activities by a participating entity for a selected property, or selected mortgage related product, and,
f. detecting patterns of conduct that reflect predatory or fraudulent activities by a participating entity teaming with one or more other participating entities.

5. The method of claim 1, further comprising the additional steps of:
a. enabling loan originators to amend loan and borrower/applicant data and information as loan terms change;
b. enabling credit counselors to notify the regulating entity of completed credit counseling and any recommendations;
c. enabling the title company or closing agent to notify the regulating entity when all loan information has been completed;
d. enabling the regulating entity to notify by automated e-mailed communications whether all data and information is complete, whether credit counseling is required for a borrower/applicant and the local agencies where it can be obtained, and notifying the title company or closing agent if entered information is accurate and verified.

6. The method of claim 1, further comprising the additional steps of:
a. providing a means to report actions and conduct expressly forbidden by applicable statutory and regulatory guidelines by any participating entity including loan originators, mortgage brokers and other lending institutions, credit counselors or credit counseling agencies, title companies or closing agents, appraisers or appraisal companies, surveyors and property inspectors, real estate brokers and real estate sales agents to a regulatory entity through the use of the data and information entered into the repository of data records pertaining to loan transactions; and,
b. enabling the regulatory entity to review such repository data records and determine any questionable fraudulent or predatory practices or pattern of conduct on the part of participating entities.

7. The method of claim 1, further comprising the additional steps to determine the financial stability of the borrower/applicant including:
a. analyzing the debt/equity ratio and cash flow for a borrower/applicant based upon data and information entered in repository data records and determining the ability of borrower/applicant to refinance based upon outstanding debts;
b. analyzing likelihood of default on loan repayment by borrower/applicant;
c. analyzing structure of refinancing loan to determine net economic benefit to the borrower/applicant; and,
d. providing notice to participating entities and borrower/applicant of results of analysis.

8. The method of claim 1, further comprising the additional steps of counseling the borrower/applicant concerning credit and awareness of financial terms including:
a. requiring credit counseling to borrower/applicants determined to be at high risk in defaulting on loan payments and/or potentially exposed to predatory lending practices;
b. preventing a loan closing from occurring on any detected loan that has amended terms that result in no tangible economic benefit to the borrower/applicants and in which borrower/applicants did or did not receive credit counseling, unless further credit counseling is received by the borrower/applicants;
c. providing borrower/applicants required to have compulsory credit counseling with a list of HUD certified credit counseling agencies provided on the basis of access to the borrower/applicants by zip code, linguistic skills, within a given distance from a given location, or any of the above combinations.

9. The method of claim 1, further comprising the additional steps of alerting the regulating entity of time dependent activities including:
a. enabling the borrower/applicant to alert the regulating entity that an application for loan has been completed;
b. automatically alerting the regulating entity when the loan originator has not entered required data within the permitted time;
c. automatically alerting the regulating entity when credit counselors has not provided an assessment within the permitted time; and,
d. automatically alerting the regulating entity when credit counselors or credit counseling agencies have assessed fees to borrowers.

10. The method of claim 1, further comprising the additional steps of preventing the closing of a loan transaction containing amended loan terms without further disclosure to the borrower/applicant any adverse financial impact to the borrower/applicant including:
a. detecting loan amendments not previously disclosed to and/or not previously agreed by the borrower/applicant and preventing the closing of the loan transaction by withholding a closing certificate unless a further disclosure of the amendments to the loan is made to the borrower/applicant and the borrower/applicant understands the financial impact and agrees to the loan amendments; and,
b. providing a closing certificate upon proof of compliance by the participating entity and the borrower/applicant to enable closing to proceed.

11. A method for regulatory agency workflow management to alert a regulating entity of a detected predatory lending practice or pattern or fraudulent activity of a participating entity comprising the steps of:
a. providing a workflow for a regulating entity containing a list of borrower/applicants meeting “out of bound” conditions including, but not limited to, high cost home loans, vulnerable geographic locales identified by zip codes, below a predefined credit score rating, poor debt-to-income ratio, appraised property value exceeding the neighboring property values by a predetermined percentage, equity percentage below predetermined percentage, mortgage value to equity value ratio exceeding a predetermined percentage, loans with unexplained related product sales, income range type, home repair, debt consolidation, etc.;
b. providing 360 degree visibility to the regulating entity through a dashboard to view statistical data (%, high, median, low, standard deviation), grouped by a number of selectable factors including, but not limited to:
i. loan rates;
ii. mortgage loan amounts;
iii. equity loan amount/percentages;
iv. property appraisal amounts;
v. cost of property;
vi. total cost of credit including points and fees assessed;
vii. sales of additional products such as insurance.
c. providing the regulating entity with the ability to acquire information to make determinations by the grouping and combination of factors with “the touch of a button” functionality with such factors selectable from the following list:
i. loan application status;
ii. zip codes;
iii. loan amounts;
iv. credit scores;
v. equity value;
vi. income level;
vii. interest rate;
viii. loan types;
ix. special loan terms.
d. providing participating financial institutions' statistics including summary, comparative, and variance information of closed loans, amounts, and rates within a user-defined time frame, and a specific area or range of areas;
e. providing summary, comparative and variance information of number of homes in foreclosure based on a user-defined time frame, rolling forward periods, zip codes, credit risk, income level;
f. providing loan originator information of loan types and data regarding where and types of loans originated and with whom;
g. providing regulating entity with ability to view data grouped by time frame; group/data comparison; summary; detail; statistical information, graphs/charts and other user defined criteria to easily detect a pattern of predatory lending.

12. The method of claim 11, further comprising the additional steps of:
a. Providing a rating dashboard to the regulating entity to review and disseminate participating entity ratings information;
b. providing a news dashboard to the regulating entity to alert the regulating entity of rates and changes to rates of U.S. Treasury bills, list participating financial institutions determined to be engaged in predatory lending activities or other illegal conduct or activities, and any other mortgage/loan critical news.

13. The method of claim 11, further comprising the additional steps of communicating and retrieving financial data and information from authoritative sources providing accurate, real time information including the capability of the regulating entity to interface over a secure communications pathway with various financial and credit bureau gateways to access, review and store in the repository of data records:
a. interest rates from credible sources;
b. U.S. treasury yields;
c. Borrower/applicant credit scores;
d. electronic transferring of loan payments to Title Companies/or to the borrower's designated financial institutions;
e. real estate tax information from tax assessor;
f. appraisal from properties within the neighborhood from current year and previous last two years;
g. foreclosures, lis pendens from recorder office; and
h. income tax filing information.

14. The method of claim 11, further comprising the additional steps of tracking the conduct and activities of any participating entity and the borrower/applicant financial stability in view of original loan terms and amendments to minimize property foreclosures and loan defaults by generating, on request of the regulating entity, a summary, detailed, comparison, variance and statistical reports, said reports grouped by the combination of data and information contained in loan application as retrieved from the repository of data records, and/or U.S. Treasury interest rates, property foreclosures, loan defaults, lis pendens, and race factors, including zip codes, ethnic groups, age, income level, and participating entities.

15. The method of claim 11, further comprising the additional steps of protecting and refraining from disclosing sensitive personal and identifying data and information including:
a. blocking and encrypting such sensitive data and information from being retrieved from the repository of data records and displayed by an unauthorized user;
b. building restricted access to such sensitive data and information with authorization levels;
c. providing flexible provisions and configurations for said authorization levels and requiring frequent configuration changes to discourage intruders and unethical behavior; and,
d. creating a protected database environment including firewall, information encryptions and decryptions, public and private keys, and user id and passwords.
